(19) United States
(12) Patent Application Publication
(10) Pub. No.: US 2009/0049654 A1
(43) Pub. Date: Feb. 26, 2009

(54) Quick-tie

(76) Inventor: David Iosue, Cleveland, OH (US)

Correspondence Address: James Lindon, Lindon & Lindon, 35104 Saddle Creek, Avon, OH, 44011, US

(21) Appl. No.: 11/842,520

(22) Filed: Aug. 21, 2007

(51) Int. Cl. F16G 11/00

(52) U.S. Cl. 24/115 R; 24/712.1; 24/129 R

(57) ABSTRACT

A tie wrap having a rope folded generally in half to define a first half of the rope and a second half of the rope. The tie wrap has a barrel lock fit with the rope so that the first half of the rope and the second half of the rope are thread through the barrel lock to define a loop in the rope. The rope is interlaced to define a first knot that terminates the loop at a first end of the tie wrap and the rope is interlaced to define a second knot at the second end of the tie wrap.

### BACKGROUND OF THE INVENTION

As technology advances and provides numerous electrical devices, we encounter a host of wires and cables. These wires and cables can become entangled and difficult to manage. In addition to wires and cables, a number of other small objects need to be gathered and bundles for ease of handling.

Current attempts to make a device for gathering and bundling of wires, cables and a host of other small objects have been largely unsuccessful. There remains a long-felt need for a device for gathering and bundling.

### BRIEF DESCRIPTION OF THE DRAWINGS

FIG. 1 is a cross sectional view in elevation of a tie wrap in accordance with the present invention.

FIG. 2 is an elevational view of the tie wrap of FIG. 1 engaged to a coil.

FIG. 3 is an elevational view of two jigs used in the production of the tie wrap of FIG. 1.

FIG. 4 is an elevational view of a pull tool used in the production of the tie wrap of FIG. 1.

FIG. 5 is an elevational view of a jig of FIG. 3 with rope used in the production of the tie wrap of FIG. 1.

FIG. 6 is an elevational view of the rope of FIG. 5 with a knot.

### SUMMARY OF INVENTION

There is provided a tie wrap having a rope folded generally in half to define a first half of the rope and a second half of the rope. The tie wrap has a barrel lock fit with the rope so that the first half of the rope and the second half of the rope are thread through the barrel lock to define a loop in the rope. The rope is interlaced to define a first knot that terminates the loop at a first end of the tie wrap and the rope is interlaced to define a second knot at the second end of the tie wrap.

There is also provided a device for spooling, measuring, and holding a rope to make a tie wrap. The device has a frame having a first leg aligned along a first axis through a mid portion of the first leg and a second leg aligned along a second axis through a mid portion of the second leg such that the first axis and the second axis diverge to define a first angle of between from about 15 degrees to about 45 degrees. The device has a first pair of posts extending generally perpendicular to the frame at a top portion of the frame. The device has a second pair of posts extending generally perpendicular to the frame at a bottom portion of the frame. The distance between the first pair of posts is less than the distance between the second pair of posts.

There is also provided a method of securing cargo with a tie wrap. The method includes providing a rope folded generally in half and having a first knot that terminates a loop at a first end of the rope and a second knot at a second end of the rope. The method includes providing a barrel lock secured to the rope. The method includes positioning the rope generally around the cargo. The method includes positioning the barrel lock adjacent to the loop at the first end of the rope.

### DETAILED DESCRIPTION OF THE INVENTION

Preliminarily, it should be noted that certain terms used herein, such as for example above, below, upper, lower, left and right, are used to facilitate the description of the invention. Unless otherwise specified or made apparent by the context of the discussion, such terms and other directional terms should be interpreted with reference to the figure(s) under discussion. Such terms are not intended as a limitation on the position in which the invention or components may be used. Indeed, it is contemplated that the components of the invention may be easily positioned in any desired orientation for use. Likewise, numerical terms such as for example “first”, and “second” are not intended as a limitation or to imply a sequence, unless otherwise specified or made apparent by the context of the discussion. The term “operatively connected” is understood to include a linking together of the portions under consideration and may include a physical engagement and/or a functional or operational connection.

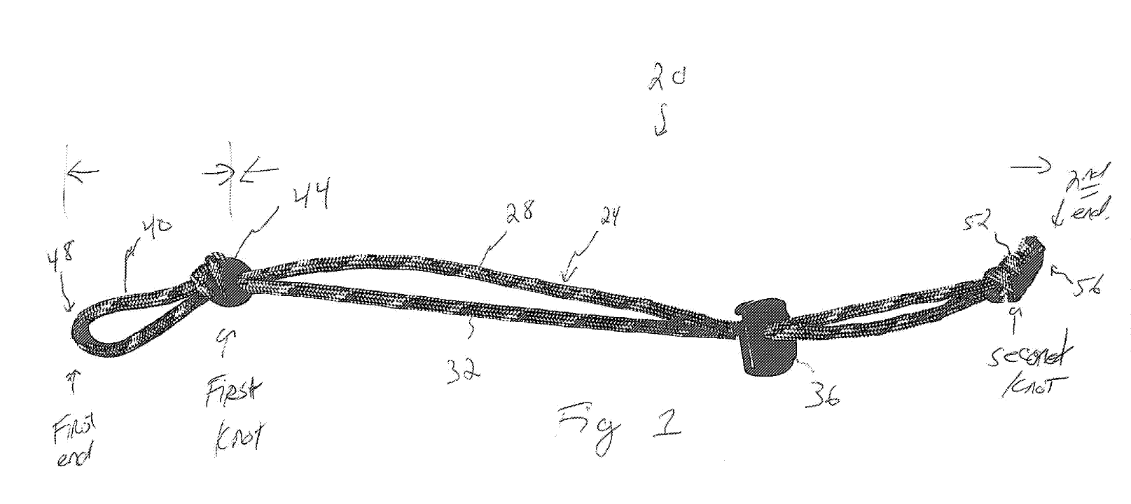

Referring now to the drawings, there is illustrated in FIGS. 1 through 6 a tie wrap, indicated generally at 20, according to the invention. The term “tie wrap” as used in this application may be understood to include, but is not limited to, any structure or functionality which may generally wind, fold, or clasp around something.

The illustrated tie wrap 20 includes a rope 24 folded generally in half to define a first half 28 and a second half 32. The first half 28 and the second half 32 may be about equal in length, but not necessarily. The illustrated tie wrap 20 includes a barrel lock 36. The term “barrel lock” as used in this application may be understood to include, but is not limited to, any locking structure or functionality which includes a resilient means biased to engage a rope secured to the locking structure. Barrel locks typically include a spring (or other resilient member), a casing and a plunger. The barrel lock may also be known as a cord lock or cord toggle.

The barrel lock 36 may be fit with the rope 24 so that the first half 28 and the second half 32 of the rope 24 are thread through the barrel lock 36 to define a loop 40 in the rope 24. The term “loop” as used in this application may be understood to include, but is not limited to, any structure or functionality which may generally define a circular or oval shape formed by a line or something such as a piece of string that curves back over itself. The rope 24 is shown generally interlaced to define a first knot 44 that terminates the loop 40 at a first end 48 of the tie wrap 20 and the rope 24 is interlaced to define a second knot 52 at the second end 56 of the tie wrap 20. The first end 48 of the tie wrap 20 is shown to the left in FIG. 1. The second end 56 of the tie wrap 20 is shown to the right in FIG. 1.

The term “knot” as used in this application may be understood to include, but is not limited to, any structure or functionality which is generally an interlacement of one or more flexible bodies forming a lump or knob. The term “rope” as used in this application may be understood to include, but is not limited to, any structure or functionality which is generally a cord that may be made by twisting together strands, other fibers, wire or the like.

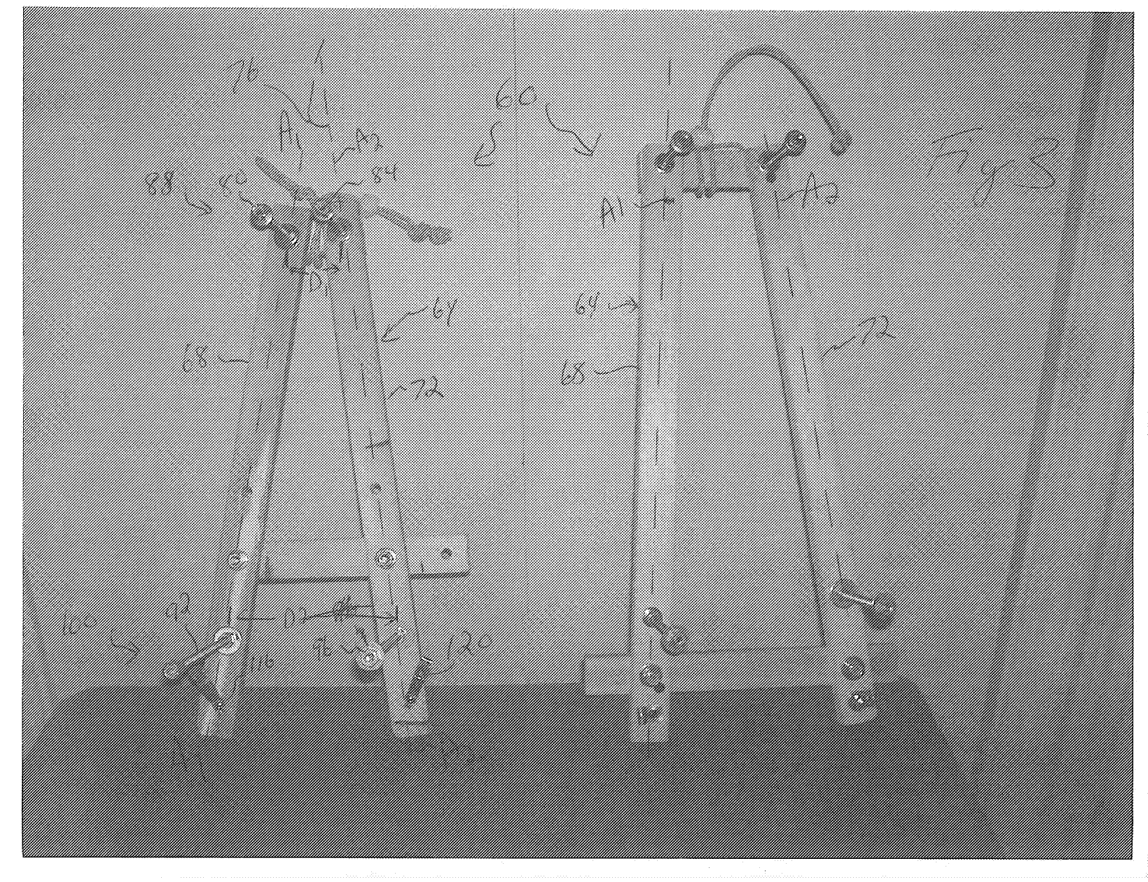

The tie wrap 20 may be made by any suitable means. One suitable means is by use of the devices shown in FIG. 3. The devices shown in FIG. 3 are jigs. The term “jig” as used in this application may be understood to include, but is not limited to, any structure or functionality which generally holds a work piece. The jig 60 includes an “A” shape frame 64. The illustrated frame 64 includes a first leg 68 aligned along a first axis A1 and a second leg 72 aligned along a second axis A2 such that the first axis A1 and the second axis A2 diverge to define an angle 76 of between about 15 degrees to about 45 degrees. The term “angle” as used in this application may be understood to include, but is not limited to, any structure or functionality which defines or creates a corner. The corner may constitute a projecting part or an enclosed or partially enclosed space. The corner may be generally straight, generally curved or arced—or partially straight or curved. The term “angle” may also include the space between two lines or surfaces at or near the point at which they touch or intersect.

The first axis A1 is positioned approximately down the middle of the length of the first leg 68. The second axis A2 is positioned approximately down the middle of the length of the second leg 72. The term “axis” as used in this application may be understood to include, but is not limited to, a generally straight line about which a body or a geometric figure rotates or may be supposed to rotate. The “axis” may be a generally straight line with respect to which a body, component, or figure may be generally symmetrical. The “axis” may be a reference line of a coordinate system. The term “leg” as used in this application may be understood to include, but is not limited to, any structure or functionality which generally defines or includes a branch or part of an object or system.

The illustrated jig 60 includes a first pair of posts 80, 84 extending generally perpendicular to the frame 64 at a top portion 88 of the frame 64. The illustrated jig 60 includes a second pair of posts 92, 96 extending generally perpendicular to the frame 64 at a bottom portion 100 of the frame 64. It will be noted that the distance D1 between the first pair of posts 80, 84 is less than the distance D2 between the second pair of posts 92, 96. The illustrated jig 60 is a suitable device, though not necessarily the only suitable device, for spooling, measuring, and holding a rope to make a tie wrap.

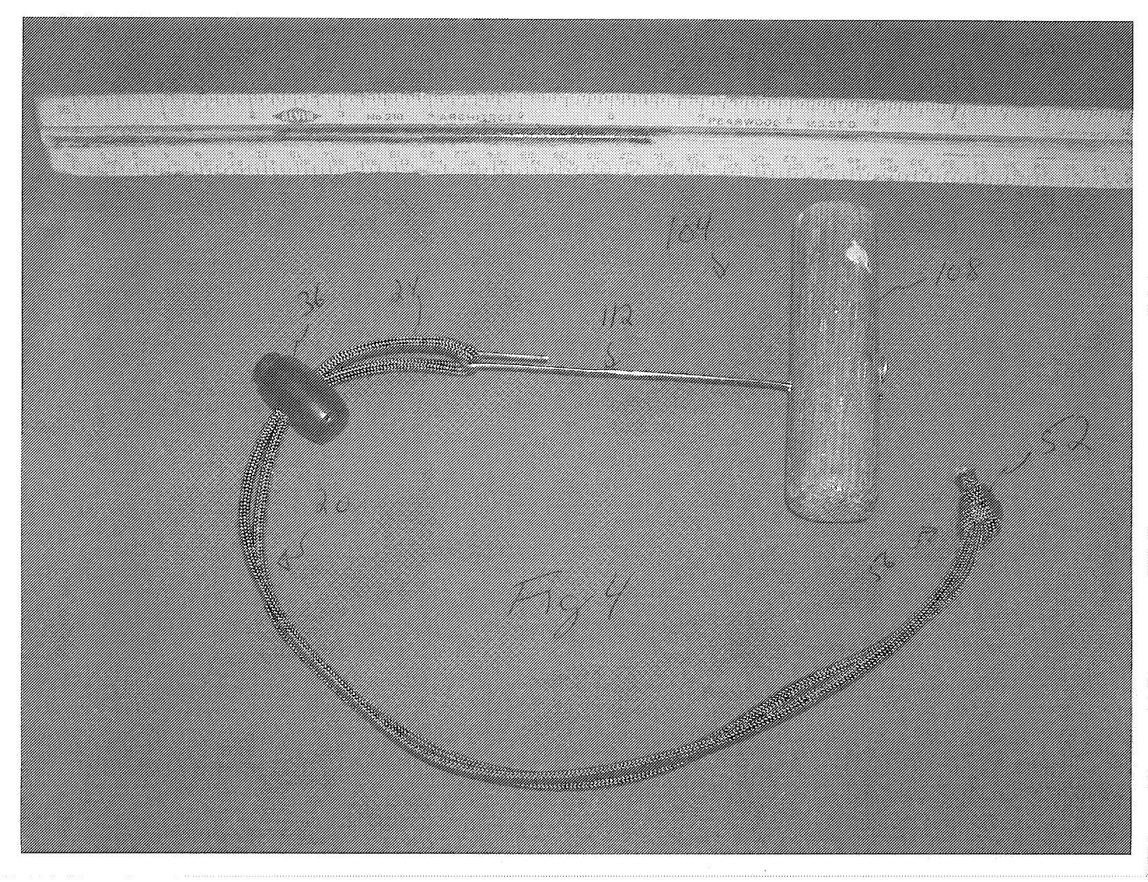

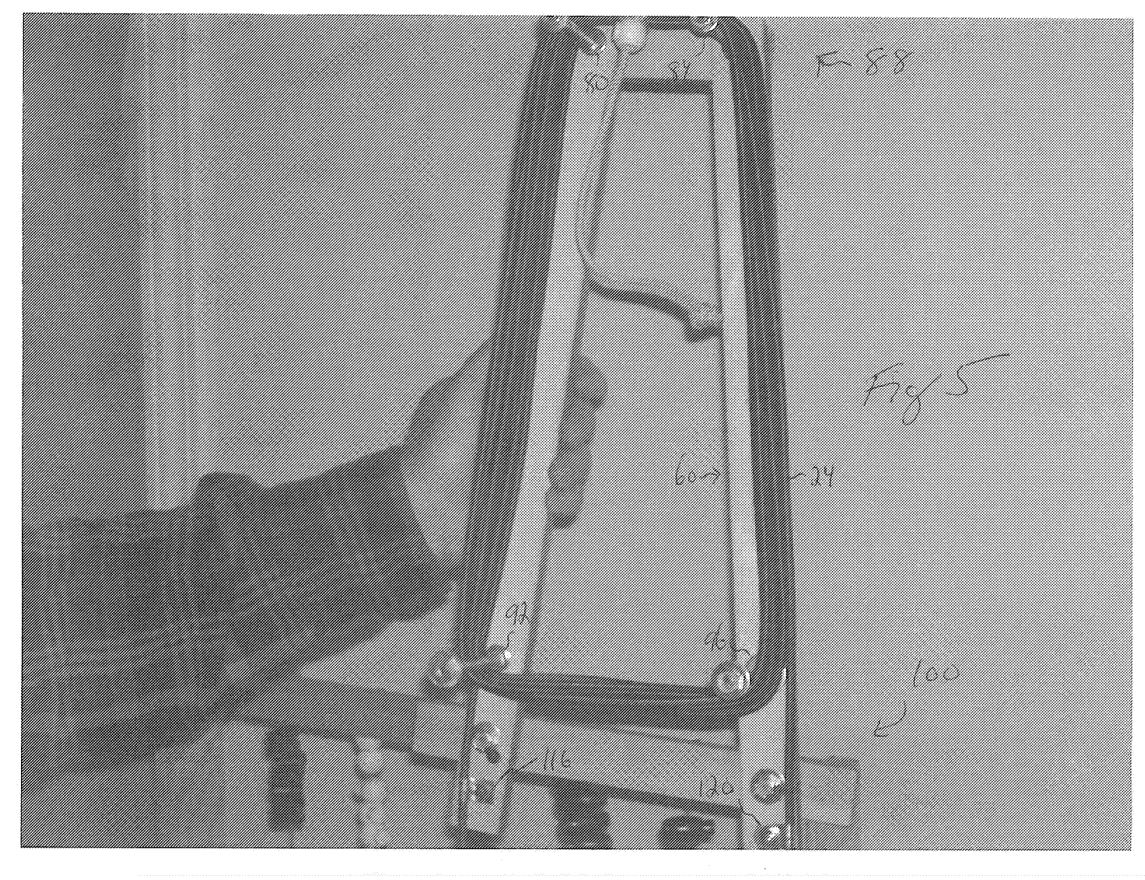

FIG. 4 and FIG. 5 illustrate a pull tool 104 used in the production of the tie wrap 20 (shown also in FIG. 1) with the jig 60 and the rope 24. The illustrated pull tool 104 includes a handle 108 secured to a hook 112. The pull tool 104 is shown pulling the rope 24 through the barrel lock 36. The rope 24 may be coiled around the first pair of posts 80, 84 at a top portion 88 of the frame 64 and the second pair of posts 92, 96 at a bottom portion 100 of the frame 64. A pair of clips 116, 120 to secure the rope 24 may be provided near the bottom portion 100 of the frame 64.

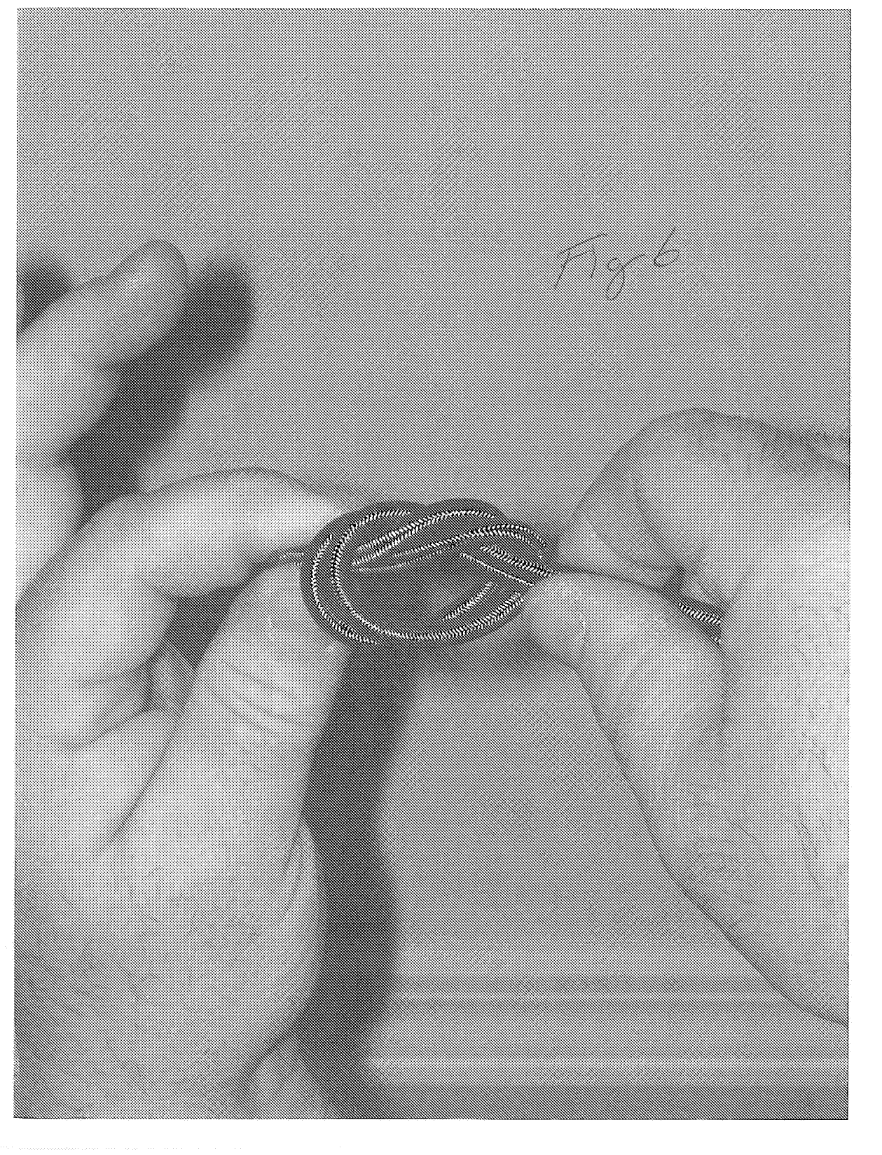

The pull tool 104 may be employed to thread the rope 24 through the barrel lock 36. The hook 112 of the pull tool 104 may have a sufficiently narrow profile to allow the hook 112 to be threaded the barrel lock 36 along with the rope 24. The term “thread” as used as a verb in this application may be understood to include, but is not limited to, any structure or functionality which may be put through a generally small opening. It will be appreciated for FIG. 4 that the rope 24 has been pulled through the barrel lock 36 after the rope 24 was cut to the desired length and removed from the frame 64. It will be noted that the second knot 52 is shown at the second end 56 to prevent the barrel lock 36 from slipping off the rope 24. The first knot 44 that terminates the loop 40 at the first end 48 may be positioned by hand as desired, as shown in FIG. 6.

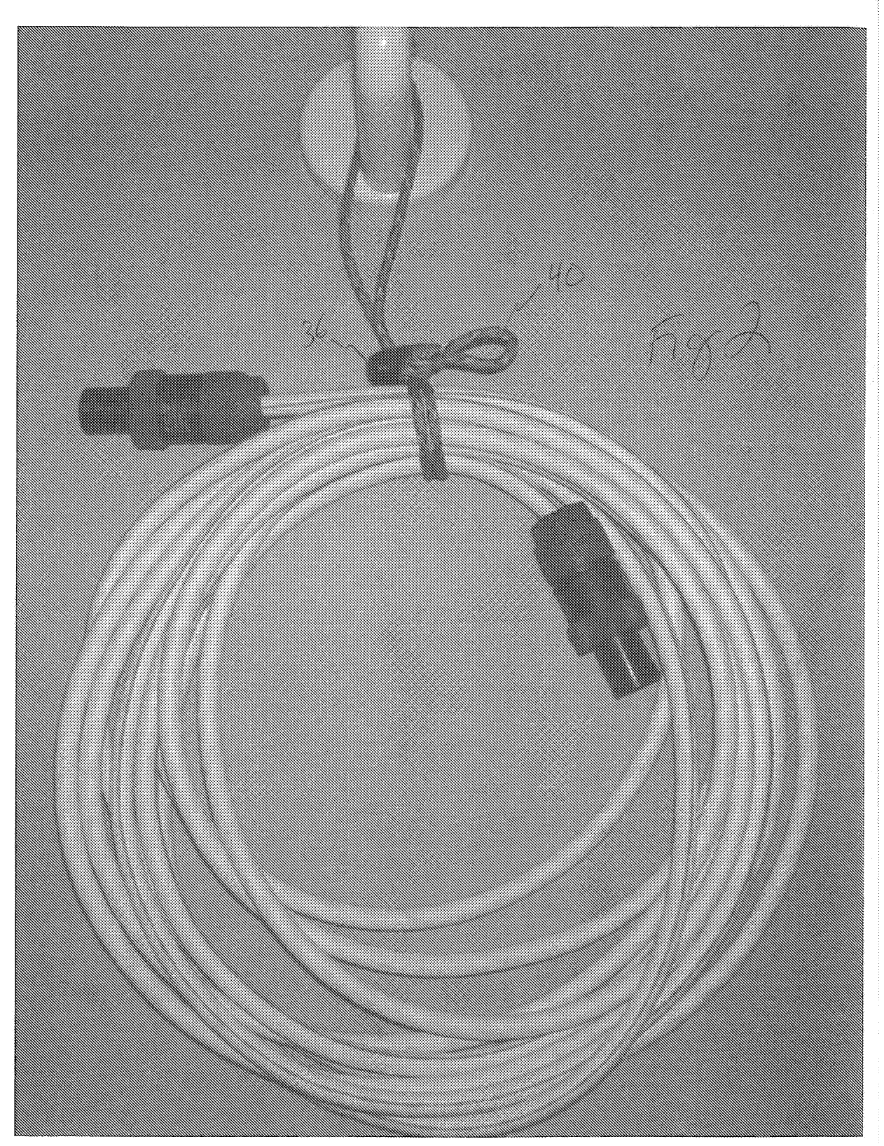

In operation, the tie wrap 20 may be employed to gather and or secure a wide variety of items—either individually or in groups, bundles, and the like. Referring now primarily to FIGS. 1 and 2, the first knot 44 that terminates the loop 40 at the first end 48 of the tie wrap 20 may be placed adjacent to, or into contact with, the second knot 52 at the second end 56 of the tie wrap 20. The term “adjacent” may include [but is not limited to] structures or components situated generally near or generally close to each other, which may or may not be touching and/or connected. It will be noted that, when the first knot 44 and the second knot 52 are so positioned, the barrel lock 36 may be positioned so as to snug the tie wrap 20 around the cargo to be secured. As shown in FIG. 2, the cargo to be secured may be a coil. The cargo to be secured may be a plurality of wires, a bundle of sticks, or the like. The loop 40 may also be positioned adjacent to, or into contact with, the barrel lock 36 in order to secure the cargo.

The invention may be made from any suitable material and by any suitable method. The invention may be adapted to fit a wide variety of uses. It will be appreciated that the components of the invention may be easily modified as needed to accommodate varying sizes and shapes.

It is to be understood that the invention is not limited in its application to the details of construction and to the arrangements of the components set forth in the accompanying description or illustrated in the drawings. The invention is capable of other embodiments and of being practiced and carried out in various ways. Also, it is to be understood that the phraseology and terminology employed herein are for the purpose of description and should not be regarded as limiting. The disclosure may readily be utilized as a basis for the designing of other structures, methods and systems for carrying out the present invention. It is important, therefore, that the claims be regarded as including equivalent constructions. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract and disclosure are neither intended to define the invention of the application, which is measured by the claims, nor are they intended to be limiting as to the scope of the invention in any way.

What is claimed is:

1. A tie wrap comprising:
a rope folded generally in half to define a first half of the rope and a second half of the rope; and
a barrel lock fit with the rope so that the first half of the rope and the second half of the rope are thread through the barrel lock to define a loop in the rope;
wherein the rope is interlaced to define a first knot that terminates the loop at a first end of the tie wrap and the rope is interlaced to define a second knot at the second end of the tie wrap.

2. The device of claim 1 wherein the first knot is spaced apart from the second knot by about ninety percent of half the length of the rope.

3. The device of claim 2 wherein the barrel lock is slidably fit with the rope.

4. The device of claim 1 wherein the barrel lock is located between the first knot and the second knot.

5. A device for spooling, measuring, and holding a rope to make a tie wrap comprising:
a frame having a first leg aligned along a first axis through a mid portion of the first leg and a second leg aligned along a second axis through a mid portion of the second leg such that the first axis and the second axis diverge to define a first angle of between from about 15 degrees to about 45 degrees;
a first pair of posts extending generally perpendicular to the frame at a top portion of the frame; and
a second pair of posts extending generally perpendicular to the frame at a bottom portion of the frame;
wherein the distance between the first pair of posts is less than the distance between the second pair of posts.

6. The device of claim 5 further comprising a retainer adapted to secure the rope during the making of the tie wrap.

7. The device of claim 5 wherein the first pair of posts are positioned substantially on the first axis and the second axis.

8. The device of claim 5 wherein the first pair of posts are positioned substantially on the first axis and the second axis.

9. The device of claim 5 further comprising a first member securing the first leg and the second leg.

10. The device of claim 9 further comprising a second member securing the first leg and the second leg.

11. The device of claim 5 wherein the first angle is within the range of from about 20 degrees to about 40 degrees.

12. The device of claim 5 wherein the first angle is about 30 degrees.

13. The device of claim 6 wherein the retainer is movably secured to the frame.

14. The device of claim 5 wherein the frame is generally “A” shaped.

15. A method of securing cargo with a tie wrap comprising:
providing a rope folded generally in half and having a first knot that terminates a loop at a first end of the rope and a second knot at a second end of the rope;
providing a barrel lock secured to the rope;
positioning the rope generally around the cargo; and
positioning the barrel lock adjacent to the loop at the first end of the rope.

16. The method of claim 15 wherein the barrel lock is located between the first knot and the second knot.

17. The method of claim 15 wherein the barrel lock is slidably fit with the rope.

18. The method of claim 15 wherein the barrel lock is located at the first end of the rope.

19. The method of claim 15 wherein the first knot is spaced apart from the second knot by about ninety percent of half the length of the rope.

20. The method of claim 15 further comprising providing a tool with a hook to pull the rope through the barrel lock, wherein the hook is threaded through the barrel lock
